(19) United States
(12) Patent Application Publication
(10) Pub. No.: US 2008/0250189 A1
(43) Pub. Date: Oct. 9, 2008

(54) Circuit and Method for Improving Operation Life of Memory

(76) Inventor: Ziyi Cheng, Tianjin (CN)

Correspondence Address: J C PATENTS, INC., 4 VENTURE, SUITE 250, IRVINE, CA, 92618, US

(21) Appl. No.: 11/914,439

(22) PCT Filed: Apr. 27, 2006
(86) PCT No.: PCT/CN06/00815

§ 371 Date: Apr. 28, 2008

(30) Foreign Application Priority Data
May 18, 2005 (CN) 200510013525.X
Mar. 16, 2006 (CN) 200610013317.4

(51) Int. Cl. G06F 12/00

(52) U.S. Cl. 711/100; 711/E12.001

(57) ABSTRACT

The present invention relates to a circuit and a method for improving operation life of original various internal or external nonvolatile memories by means of long-life nonvolatile memory chips. In the case that the hardware structure, interface type, packaged type and operation condition of existing various nonvolatile memories are not changed yet, only long-life nonvolatile memory chips are added into original hardware structure, and correspondingly, long-life nonvolatile memory addresses are added into original memory addresses in main boot-block for the memories, the original device driver or operating system is modified, so as to increase operation life of the memories greatly.

### FIELD OF INVENTION

The present invention relates to computer memory technique, especially to a circuit and a method for improving operation life of internal or external memories.

### BACKGROUND OF THE INVENTION

At present, the storage technique of nonvolatile memories such as magnetic memories, optical memories and semiconductor memories has been developed steadily, bringing about steady increment in memory capacity and steady improvement in memory performances of hard disk, read write optical disk, magnetic disk, optical disk and mobile semiconductor memory card. Because of their operation life, their application is then limited in some fields.

By internal and/or external nonvolatile memories for data files is meant, but not limited to, optical memory, magnetic memory, nonvolatile semiconductor memory and so on with medium-scale or higher rewritable frequency limit. The relative operation life of each kind of disks (including hard disks) is longer, maybe several years. During their service periods, [symbol] zero-address and FAT band is easily destroyed so that all the stored data in the hard disk will be lost. The rewrite operation frequency of existing rewritable optical disk is about several thousand times, the rewrite operation frequency of existing flash semiconductor memory card is about 10⁶ times, and their full-load operation life is about 200 hours. Those internal and/or external nonvolatile memories of digital data files are suitable for general stored files, but they will be easily destroyed in case they are used in rewriting and rereading over and over again, such as virtual memory for computer or the data memory in black box for flight data recorder. For internal and/or external nonvolatile memories for digital data files that have such memory devices as optical memory, magnetic memory, nonvolatile semiconductor memory with medium-scale or higher rewritable frequency limit, their operation life should be improved.

At present, the studies on increasing operation life of internal and/or external nonvolatile memories for digital data files focus onto increasing operation life of memory devices themselves. In general, those studies may change memory devices, existing memories or computer system hardware, which will greatly increase manufacturing cost and operating cost of newly-developed memories.

### SUMMARY OF THE INVENTION

The principal object of the present invention is to provide a circuit for improving operation life of internal or external nonvolatile memories for digital data files under the condition that the hardware structure, interface type, packaged type and operation condition of various existing nonvolatile memories are not changed, and at the same time, to provide a method for data access control of the memories with that structure.

The circuit of the present invention for improving operation life of the memories includes:

main memory device;

main memory device controller to control data access of main memory device, forming main memory with main memory device;

long-life memory device to store basic information and/or other data that need to be rewritten and reread frequently;

long-life memory device controller to control data access of long-life memory device, forming long-life memory with long-life memory device.

The present invention also provides a method for improving operation life of the memories by means of said circuit. When a memory control module is used to access data onto/from memories, the following steps may be included:
(1) Initialize long-life memory, then read out basic information and/or other data that need to be rewritten and reread frequently from main memory and store them into a long-life disk;
(2) Set up a relation table between the addresses of basic information and/or other data stored in the long-life disk, which need to be rewritten and reread frequently, and the addresses in the master disk;
(3) During data access, retrieve data addresses for access and check them whether they are the address in the relation table. If the answer is positive, the access operation will be performed in the long-life memory, and otherwise in the main memory.

For said method of improving operation life of the memories, in the case that the main memory is a changable-device memory, when turning off or taking out changable device from the main memory, the following steps may be included:
(1) Determine whether the power supply is interrupted. If interrupted, start emergency power supply;
(2) Store basic information and/or other data stored in the long-life disk, which need to be rewritten and reread frequently, into the main memory.

When making partitions of the main memory, it is able to store the basic information in each partition into the main memory, and late on, access operation of basic information for digital data files can be carried out directly in long-life memory.

When making partitions of the master disk, it is able to store the basic information in each partition into the long-life memory, and late on, access operation of basic information for digital data files can be carried out directly in long-life memory.

The present invention uses nonvolatile random memories that have more read-write operation frequency and longer operation life than that of the main memory devices, and/or longer-life nonvolatile memories and/or volatile random memories instead of the “basic information” partition with high access frequency in the store devices with medium-scale or higher-scale write frequency limit in internal and/or external nonvolatile data file memories, and/or the memories in the memory partition that used as virtual memories to be needed to read/write frequently for reducing the limits of rewrites of the main memory devices, so as to increase operation life of the internal and/or external nonvolatile data file memories. New-added physical memories that consist of long-life memory devices may be also used as multi-function memories such as those memories for storing applied data files, and/or buffer memories for temporarily storing data files, or other kinds of memories.

Notes:
(1) By “Data File” is meant various data or data files, which are needed to be stored, including basic input/output system (BIOS) on the main board.
(2) By “Internal and/or external nonvolatile data file memory” is meant nonvolatile memory devices and nonvolatile memories mount between integrated circuit (IC) (for example, in the inside of one-chip processor) and/or main board and/or between external equipment and main board for storing each kind of data and data files.
(3) Taking DOS system as an example, the “basic information” and/or other kinds of data that need to be read and written frequently when internal and/or external nonvolatile data file memories are making data access and store operations include: Partition Table, ROOT, MBR, DBR, FAT table and other memory information and file store address information. ROOT DIR (Directory) is recordable log catalog or file in ROOT DIR partition, its damage may cause boot troubles. MBR (Master boot record) can be divided into two parties: MBP (Master Boot Program) and Partition Table. DBR can store start program of DOS, its main function is to store 2 hidden DOS files (IO.SYS, MSDOS.SYS). FAT table (File Allocation Table) is a chained file in Microsoft FAT file system for disk data (file) index and location, and may be different in different operating, for example, WIN 98 or WIN 2000 and WIN XP use FAT 32 or NTSF file allocation table. In the present invention they are called “basic data” or “basic information”.
(4) The memories that consist of long life or longer life nonvolatile memory devices are called “Long-Life Memory or Long-Life Disk”.
(5) The memories that consist of short life or shorter life memory devices are called “Master Memory or Master Disk”.
(6) By long-life or longer life nonvolatile memory devices are meant such memory devices which have more repeat times of read and write operations than medium life nonvolatile memory devices. In the present invention, long-life nonvolatile memory devices or memory chips can be called relatively longer life nonvolatile memory devices or relatively longer life nonvolatile memory chips, and medium life nonvolatile memory devices can be called relatively shorter life nonvolatile memory devices or relatively shorter life nonvolatile memory chips.
   In comparison with short-life nonvolatile memory devices with less read/write frequency in main memory device, long-life nonvolatile memory devices with more read/write frequency have higher heat-resisting, surge-resistant and vibration resisting capabilities and other excellent performances so that they have long operation life.
(7) Long-life or longer life nonvolatile memory devices include long-life or longer life nonvolatile RAM chips or nonvolatile ROM chips, or shorter life nonvolatile memory devices include long-life or longer life nonvolatile RAM chips or nonvolatile ROM chips. They may consist of each kind of materials and are called long-life nonvolatile memory chip or long-life nonvolatile memory device.
   Long-life nonvolatile memory chip or long-life nonvolatile memory device may include nonvolatile RAM and/or ROM with unlimited read-write frequency, magnetic RAM (MRAM) or resistance RAM (RRAM), nonvolatile RAM and/or ROM with high read-write frequency, ferromagnetic RAM/ferroelectric RAM (FeRAM) or phase transformation materials OUM memory (Phase transformation internal memory PRAM), superhigh density memory chip (MILLIPEDE) device, or medium-life FlashROM semiconductor RAM and ROM and other kinds of long-life or longer life chips or long-life or longer life nonvolatile memory devices. A basic principle is that longer-life memory device is used instead of short-life memory device that is needed to be read and written.
(8) Relatively-shorter-life multiple internal and/or external nonvolatile memories include magnetic disk, optical disk, semiconductor nonvolatile memory devices and various shorter life other multiple nonvolatile memory devices in internal and/or external memories, and are called shorter life nonvolatile memory device in this invention statement.

### BRIEF DESCRIPTION OF THE DRAWING

FIG. 1 is a block diagram of hardware layout of this invention;

FIG. 2 is a block diagram of hardware layout for 1^{st} embodiment of this invention;

FIG. 3 is a block diagram of hardware layout for 2^{nd} embodiment of this invention;

FIG. 4 is a block diagram of hardware layout for 3^{rd} embodiment of this invention;

FIG. 5 is a block diagram of hardware layout for 4^{th} embodiment of this invention;

FIG. 6 is a block diagram of hardware layout for 5^{th} embodiment of this invention;

FIG. 7 is a block diagram of hardware layout for 6^{th} embodiment of this invention;

FIG. 8 is a flow chart of a complete access operation of changeable memory device;

FIG. 9 is a flow chart of operation and turn-off of changeable memory device;

FIG. 10 is an installation program of long-life disk;

FIG. 11 is a flow chart of store operation of long-life memory (operation program).

FIG. 12 is a flow chart of store operation of the memory by changed operation system;

FIG. 13 is a block diagram of hardware layout for another embodiment of this invention.

### DETAILED DESCRIPTION OF THE INVENTION

Referring to the drawings in greater detail we have described embodiments of the present invention and its functions, characters and advantages as follows:

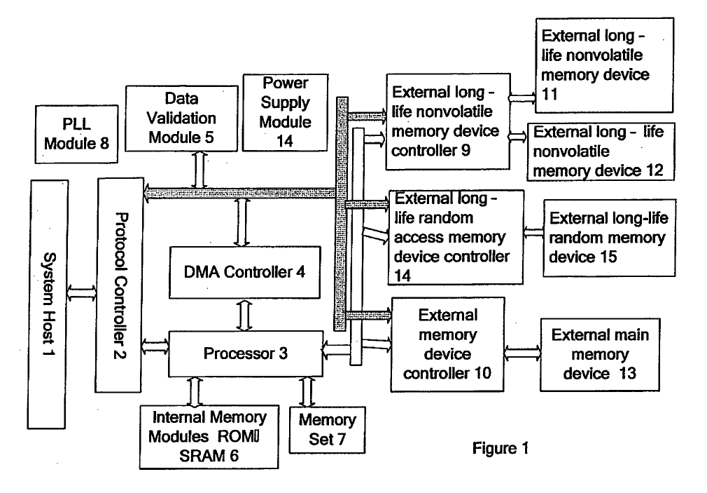

FIG. 1 is a block diagram of hardware layout of this invention.

For the sake of convenience, the description of the block diagrams of hardware layout and embodiments of an inventive patent “Memory Control Chips and Data Memory Control Method” (Applicant: Shenzhen Langke Scientific & Technical Co., Ltd.; Inventors: Deng Guoshun, Cheng Xiaohua, Xiang Feng; Application Date: Jul. 28, 2003; Application Number: 03140023.x) is used for description of the block diagrams of hardware layout and embodiments of the present invention. When using in different kind of internal/external and/or nonvolatile data file memories, those memories may use different and suitable memory control chip, circuit type and data access control method, for example, when using into hard disk, its control circuit should use the memory control chip and method for the hard disk. As the key points of this invention are not the memory control chip and data access control method of said patent, for further details of them please refer to said patent and materials of each kind of memory control chips for those memory.

System host 1, including but not limited to personal computer, notebook computer, palmtop, personal digital assistant (PDA), digital photo album, digital camera, digital recorder, digital video recorder, digital television camera, MP3 recorder, broadcaster, MP4 recorder, pickup camera, broadcaster, and other electronic/electro-machinery products that need internal/external digital nonvolatile data file memories. There are a controller 2 and system host 1 in memory control chip. The controller 2 and the system host 1 are connected each other through protocol, and the digital transmission between them is carried out also though protocol.

Its functional modules include memory control modules that consist of processor 3 (MCU), DMA controller 4, protocol controller 2, data validation module 5, internal memory module 6, PLL module 8 and memory group 7, power supply module 14, external memory device controller 10, external main memory device 13. The main characteristics of the present invention are: newly-added external long-life nonvolatile memory device controller 9, external long-life nonvolatile memory device 11, external long-life nonvolatile memory device 12, external long-life RAM device controller 14, external long-life RAM device 15, external memory device controller 10 and external main memory device 13.

Processor 3 can take programmable single-chip processor (micro controller) as a controller of full memory control chip, and can also take DSP controller, Risk controller, X86 controller, programmable controller, gate-array chip controller and each kind of processors (MCU). The control function and parameter allocation function can be carried out through access of DMA controller 4, protocol controller 2, data validation module 5, internal memory module 6, PLL module 8 and memory group 7, external memory device controller 10, external long-life nonvolatile memory device controller 9, external long-life RAM device controller 14 and so on.

Said external memory device controller 9, 10 and 14 are used to control time sequence of external memory devices, can be (but not limit to) long-life nonvolatile memory device controller, flash memory device controller, MRAM controller, RRAM (resistance RAM) controller, ferromagnetic RAM/ferroelectric RAM (FeRAM) controller, phase transformation materials OUM memory (Phase transformation internal memory PRAM) controller and so on.

There are two operation modes for memory control chip: processor mode and DMA mode, whichever is suitable according to the parameters related to the memories. For processor mode, it is processor 3 that controls the data bus and address bus of the full chip. Using instructions, processor 3 can access internal memory module 6, protocol controller 2, external memory device controller 9, 10 and 14 etc. Said processor mode is mainly used to configure protocol controller 2. For DMA mode, it is DMA controller 4 that controls the data bus and address bus of the full chip and sets up DMA data transmission channel as per different parameter for carrying on various DMA data transmission. Said DMA data transmission include the following types, but not limited to: from protocol controller to external memory device controller, from protocol controller to internal memory module, from internal memory module to protocol controller, from internal memory module to external memory device controller, from external memory device controller to internal memory module, from external memory device controller to protocol controller, as well as erasing information and programming in external memory devices and so on.

The present invention uses external long-life nonvolatile memory device controller 9 to control external long-life nonvolatile memory device 11 instead of “basic Information” and other data stored in external main memory device 13 controlled by external memory device controller 10, so as to increase operation life of external main memory device 13 controlled by external memory device controller 10.

The present invention uses external long-life nonvolatile memory device controller 9 to control external long-life nonvolatile memory device 12 and/or external long-life RAM device controller 14, and then control external long-life RAM device 15 as virtual memory instead of external main memory device 13 controlled by external memory device controller 10, so as to increase operation life of virtual memory. It is determined whether or not external long-life nonvolatile memory device 12 and/or external long-life RAM device 15 is installed according to the design plan. They may be taken as virtual memory r other kinds of memories for different purposes.

External long-life nonvolatile memory devices 11 and 12 controlled by external long-life nonvolatile memory device controller 9 can be same kind or different kind of memory devices, or only one is used in the system.

According to design requirement, external long-life RAM device controller 14 and external long-life RAM device 15 controlled by RAM device controller 14 may not be used.

For this embodiment, long-life nonvolatile memory chip with infinite read/write capacity and long-life nonvolatile memory devices such as FlashRom semiconductor data RAM/ROM can be used, and in addition, nonvolatile RAM with infinite read/write capacity such as magnetic RAM (MRAM) or resistance RAM (RRAM) can also be used instead of longer-life nonvolatile RAM or ROM such as ferromagnetic RAM/ferroelectric RAM (FeRAM) controller, phase transformation materials OUM memory (Phase transformation internal memory PRAM), and superhigh density memory chip (MILLIPEDE) device.

Power supply module 14 may not be used according to design. Battery or accumulator or capacitor charged can be used for its power supply. It can be used for short-time power supply to the memories in the case external power supply trouble is happened, so as to prevent data against losing, and in addition, can be used for power co-supply to the memories, for example, when the power supply is turning off or when the memory has received turnoff instruction from host 1 or when the data stored in external long-life nonvolatile memory device 11 is written into external main memory device 13.

Internal and/or external nonvolatile data file memories of the present invention have multiple physical partitions. A physical partition can be defined as a logic sub-partition or several logic sub-partitions. It is possible to set up virtual disk on that physical partition for virtual disk or on the physical partition in master memory device. That virtual disk can be used as various kinds of memory disks such as buffer memories. “Basic Information” shall be recorded into the physical partition on “long-life Disk” and the main files will be recorded onto master memory device disk. Don't set up “Basic Information” read-write partition on master memory device physical partition, which may reduce operation life of master memory devices. It is necessary to set up “Basic Information” on the physical partition of master memory device, being as a duplicate record to prevent “Basic Information” from losing. Recording master file data shall start from medium life master memory device. It would be better to record new data as per cancel time order each time when recording new data onto master memory device instead of finding out and recording into space available so that it could prevent the start section of master memory device from damaging because of frequently reading and writing.

The memories of the present invention can be divided into partitions according to design, for example:

(1) Dividing partitions as per physical structure:
(a) For a physical partition that consists of external long-life nonvolatile memory device 11, data access in that partition instead in external main memory device 13 is to prevent external main memory device 13 from damaging because of frequently reading and writing file data. Said partition is called “Long-Life Disk” in the present invention.
(b) External long-life nonvolatile RAM or ROM device controller 9 controls a physical partition consisting of external long-life nonvolatile memory device 12, external long-life RAM device controller 14, and external long-life RAM device 15. That partition can be taken as a virtual memory to increase operation life of external main memory device 13 controlled by external memory device controller 10 when taking it as a virtual memory. Said partition is called “Virtual Disk” in the present invention. Whether or not “Virtual Disk” should be installed in external or external memory shall be determined according to design. In the case that the use of the memory is only to store files, then “Virtual Disk” may not be installed. If a memory device needs a virtual memory operation system, then “Virtual Disk” may be installed. It can be used for other memories with different uses such as buffer memory. According to design requirements, external long-life nonvolatile memory device or those physical partitions which consist of external long-life nonvolatile memory device can be taken as other memories with various uses such as data file memory, virtual memory, buffer memory and so on.
(c) For the physical partitions that consist of external main memory device 13 controlled by external memory device controller 10, file data are accessed in that partition, which is called “Master Disk” in the present invention.
(2) Several physical disks are integrated into a large partition. Recording master file data shall start from medium life master memory device. It would be better to record new data as per cancel time order each time when recording new data onto master memory device instead of finding out and recording into space available so that it could prevent the start section of master memory device from damaging because of frequently reading and writing. Access of some memory information and file data that need to be frequently rewritten and reread is carried out in the physical partition that consists of external long-life nonvolatile memory device 11. An address partition, which consists of external long-life nonvolatile memory device 12 and/or external long-life RAM device 15 can be taken as virtual memory for data access.
   (d) External long-life nonvolatile memory devices 11 and 12 can be integrated into a chip, on partitions in that chip there can set up “Long-Life Disk” or “Virtual Disk”.
   (e) The information that memory includes long-life disk and master disk shall be written into “Internal Initialization Parameter Table” (or called “Internal Initialization Parameter Set”) and/or MBR (Master Boot Recorder). In general, that “Internal Initialization Parameter Table” (“Internal Initialization Parameter Set”) is in BIOS of a CPU that controls external memory. In the case the long-life nonvolatile internal memory in the host shall be used, it is necessary to write the information in nonvolatile memory including long-life nonvolatile memory device and short-life nonvolatile memory device, into “BIOS” in the host. Of course, “Internal Initialization Parameter Table” (“Internal Initialization Parameter Set”) may be in other type of internal/external memories and called other name with same function as “Initialization Parameter Table”.

The long-life nonvolatile memory hardware of the present invention should be used in conjunction with the software (Program) that can write “Basic Information” in master memory into long-life disk, and later on when read/write operation for the master disk is carried out, with memory device drive program or memory operation system program stored in “Basic Information” of the master disk of long-life disk.

If long-life flash memory of the present invention is used as hard memory for computer, the information “Internal Initialization Parameter Set” in that long-life flash memory should be detected automatically by auto-detection function (IDE HDD AUTO DETECTION) in BIOS hard disk of the master board, or read out in proper sequence according to requirements of BIOS program. Related information should be written into long-life disk or master disk in the memory. Said “Internal Initialization Parameter Set” may include the information that should be identified, including MBR (Master Boot Record) information in memory device.

If long-life nonvolatile memory devices are added into hard disk, it is necessary to add information about long-life disk into “Initialization Parameter Set” in hard disk (“Initialization Parameter Set” may include the information that should be identified, including MBR (Master Boot Record) information in memory device) should be detected automatically by auto-detection function (IDE HDD AUTO DETECTION) in BIOS hard disk of the master board, or read out in proper sequence through special program and/or operation system and CPU that controls hard disk according to requirements of BIOS program.

There are stored 69 different files in “Initialization Parameter Set” in hard disk in module sequence with same names as that of parameters called by BIOS program, in which partial parameters are described as follows: Basic management program in DM hard disk, PL permanent bug table, TS bug magnetic channel table, HS real number of physical head and collating sort, SM highest encryption status and cipher, SU user encryption status and cipher, CI hardware information, including used CPU model, BIOS version, head type and disk type etc, FI manufacturer information, WE write error record table, RE read error record table, SI capacity determination, maximum user capacity (MAXLBA), number of external logic heads that have been changed (in general, it is 16), number of sectors in each magnetic channel (in general, it is 63), ZP region allocation information, maximum physical capacity (one disk is divided into 15 regions, and there are different number of sectors in every region, so as to calculate maximum physical capacity) and so on.

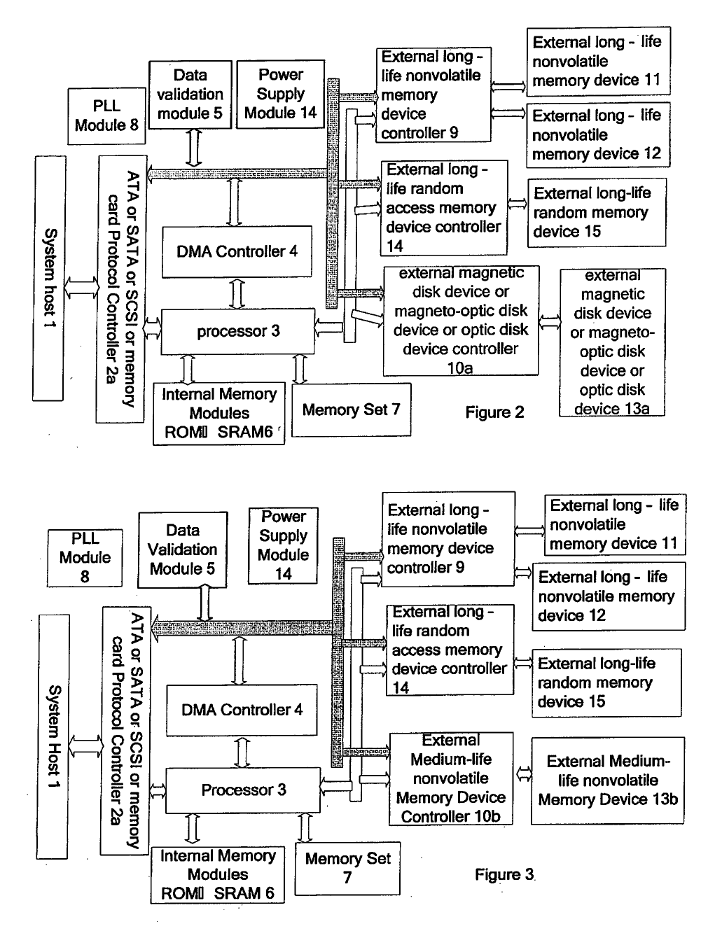

FIG. 2 is a block diagram of hardware layout for 1^{st} embodiment of this invention, embodying a first form of the invention, shown a circuit in memory control chip for the memories of magnetic disk, magneto-optic or optical disk.

The hardware layout in that embodiment is same as that in FIG. 1 in the main, but protocol controller 2 in this embodiment is ATA, SATA, SCSI or other memory card protocol controller 2b which is used to make transmission of information and access of data for external magnetic disk device or magneto-optic disk device or optic disk device 13a controlled by memory device controller 10a of external magnetic disk driver (HD), magneto-optic disk driver (MO or MD) or optic disk driver (DVD-RW, DVD-RAM etc).

In that circuit:

External long-life nonvolatile memory device controller 9 is used to control data access of external long-life nonvolatile memory device 11, which is taken as long-life disk memory instead of medium life nonvolatile memory devices that need to read/write “Basic Information” frequently and the memory devices in other data memory region.

External long-life RAM device controller 14 is used to control external long-life RAM device 15, and/or external long-life nonvolatile memory device controller 9 is used to control external long-life nonvolatile memory device 12, which is taken as virtual memories (virtual disk), instead of memory devices that need to be read/written frequently in medium life nonvolatile memory (Master Disk)

FIG. 3 is a block diagram of hardware layout for 2^{nd} embodiment of this invention, shown a circuit in memory control chip mainly for the memories of medium life nonvolatile semiconductor disk.

The hardware layout in that embodiment is same as that in FIG. 1 in the main, but protocol controller 2 in this embodiment is ATA, SATA, SCSI or other memory card protocol controller 2b which is used to make transmission of information and access of data for external medium life nonvolatile semiconductor memory device 13b controlled by external medium life nonvolatile semiconductor memory device controller 10b. That circuit can be used for memory card or memory disk, which consists of nonvolatile semiconductor memory devices, such as CF card, memory disk (DOM disk) and so on.

In that circuit:

External long-life nonvolatile memory device controller 9 is used to control data access of external long-life nonvolatile memory device 11, which is taken as long-life disk memory instead of medium life nonvolatile semiconductor memory devices that need to read/write “Basic Information” frequently and the memory devices in other data memory region. External long-life RAM device controller 14 is used to control external long-life RAM device 15, and/or external long-life nonvolatile memory device controller 9 is used to control external long-life nonvolatile memory device 12, which is taken as virtual memories (virtual disk), instead of memory devices that need to be read/written frequently in medium life nonvolatile semiconductor memory (Master Disk).

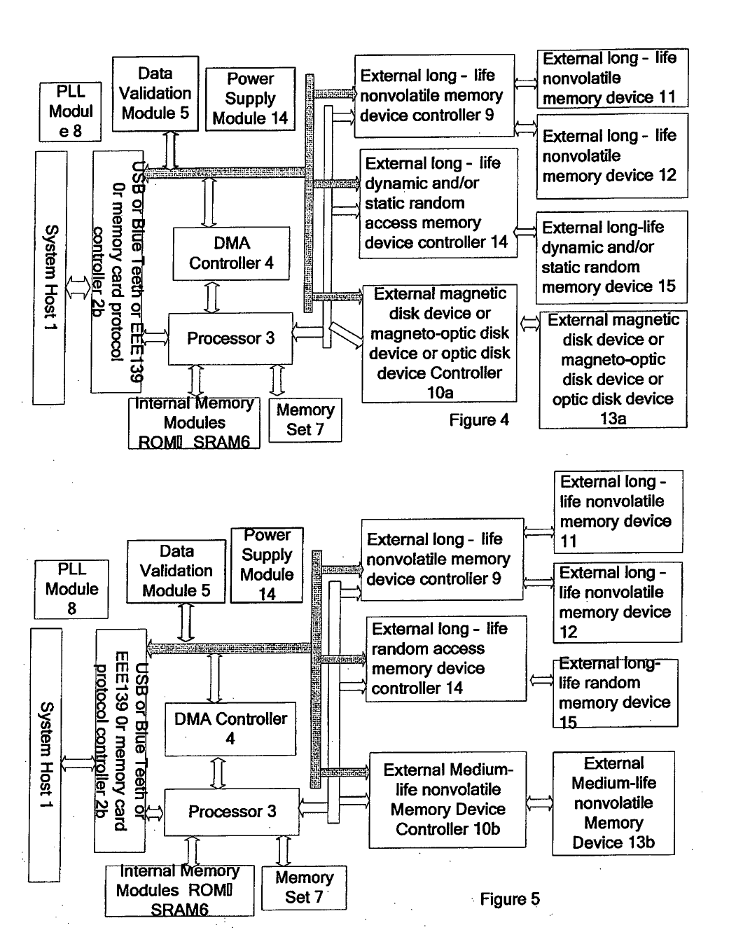

FIG. 4 is a block diagram of hardware layout for 3^{rd} embodiment of this invention, shown a circuit for memory control chip of magnetic disk, magneto-optical or optical disk or other memories.

The hardware layout in that embodiment is same as that in FIG. 1 in the main, but protocol controller 2 in this embodiment is USB, Blue Teeth, or IEEE 1394, or protocol controller 2b of memory card, which is used to make transmission of information and access of data for external magnetic disk, magneto-optic or optical disk memory devices 13a controlled by external magnetic disk, magneto-optic or optical disk memory devices controller 10a.

In that circuit:

External long-life nonvolatile memory device controller 9 is used to control data access of external long-life nonvolatile memory device 11, which is taken as long-life disk memory instead of medium life nonvolatile memory devices that need to read/write “Basic Information” frequently and the memory devices in other data memory region.

External long-life RAM device controller 14 is used to control external long-life RAM device 15, and/or external long-life nonvolatile memory device controller 9 is used to control external long-life nonvolatile memory device 12, which is taken as virtual memories (virtual disk), instead of memory devices that need to be read/written frequently in medium life nonvolatile memory (Master Disk).

FIG. 5 is a block diagram of hardware layout for 4^{th} embodiment of this invention, shown a circuit for memory control chip of long-life nonvolatile semiconductor disk or other memories.

The hardware layout in that embodiment is same as that in FIG. 1 in the main, but protocol controller 2 in this embodiment is USB, Blue Teeth, or IEEE 139, or protocol controller 2b of memory card, which is used to make transmission of information and access of data for external medium life nonvolatile semiconductor memory device 13b controlled by external medium life nonvolatile semiconductor memory device controller 10b.

In that circuit:

External long-life nonvolatile memory device controller 9 is used to control data access of external long-life nonvolatile memory device 11, which is taken as long-life disk memory instead of medium life nonvolatile semiconductor memory devices that need to read/write “Basic Information” frequently and the memory devices in other data memory region. According to design requirements, external long-life RAM device controller 14 is used to control external long-life RAM device 15, and/or external long-life nonvolatile memory device controller 9 is used to control external long-life nonvolatile memory device 12, which is taken as virtual memories (virtual disk), instead of memory devices that need to be read/written frequently in medium life nonvolatile semiconductor memory (Master Disk).

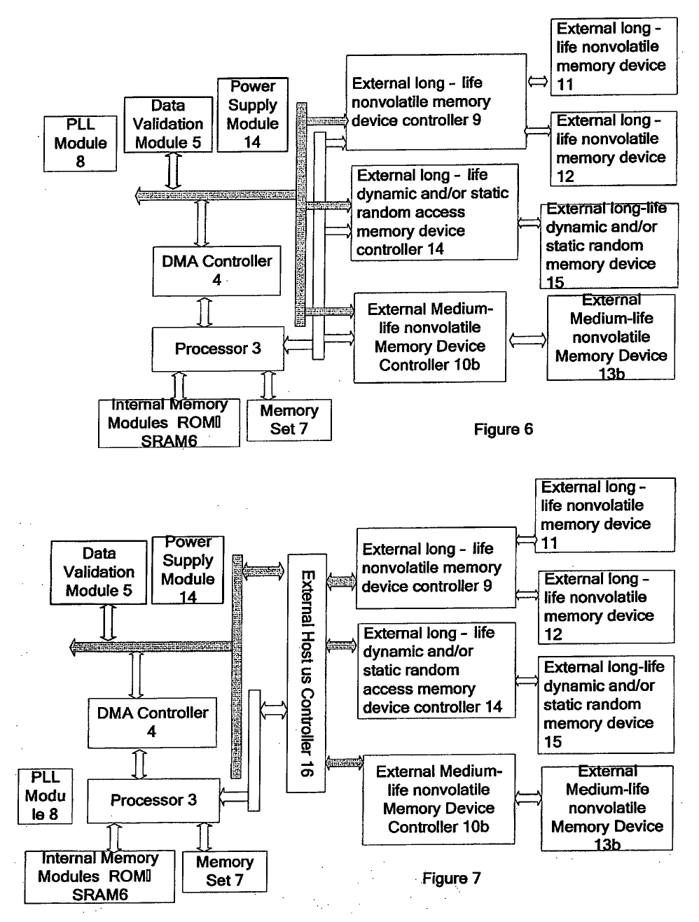

FIG. 6 and FIG. 7 are block diagrams of hardware layout for 5^{th} and 6^{th} embodiments of this invention individually, shown a circuit in memory control chip mainly for internal medium life nonvolatile semiconductor memories.

The hardware layout in those embodiments are same as that in FIG. 1 in the main, but there is no protocol controller 2 and the host 1 in those two embodiments. As shown in FIG. 6, internal data bus, address bus and control bus of the host, or as shown in FIG. 7, external interface bus controller 16 such as PCI bus controller etc can directly control internal long-life nonvolatile memory devices 11 and 12 controlled by internal long-life nonvolatile memory device controller 9 and external long-life RAM device 15 controlled by external long-life RAM device controller 14 for data access, or as shown in FIG. 2, through controlling of protocol controller 2b of ATA or SATA or SCSI or memory card, internal long-life nonvolatile memory device controller 9 can control internal long-life nonvolatile memory devices 11 and 12, and/or external long-life RAM device controller 14 can control external long-life RAM device 14, and external medium life nonvolatile semiconductor memory device controller 10b can control external medium life nonvolatile semiconductor memory device 13b for data access. External interface bus controller, internal longer-life nonvolatile RAM or ROM device controller, and internal long-life nonvolatile memory can be taken as the memories that need to read/write file data frequently and/or virtual disk memories.

In that circuit:

Internal long-life nonvolatile memory device controller 9 is used to control data access of internal long-life nonvolatile memory device 11, which is taken as long-life disk memory instead of medium life nonvolatile semiconductor memory devices that need to read/write “Basic Information” frequently and the memory devices in other data memory region.

Internal long-life RAM device controller 14 is used to control internal long-life RAM device 15, and/or internal long-life nonvolatile memory device controller 9 is used to control internal long-life nonvolatile memory device 12, which is taken as virtual memories (virtual disk), instead of memory devices that need to be read/written frequently in medium life nonvolatile semiconductor memory (Master Disk).

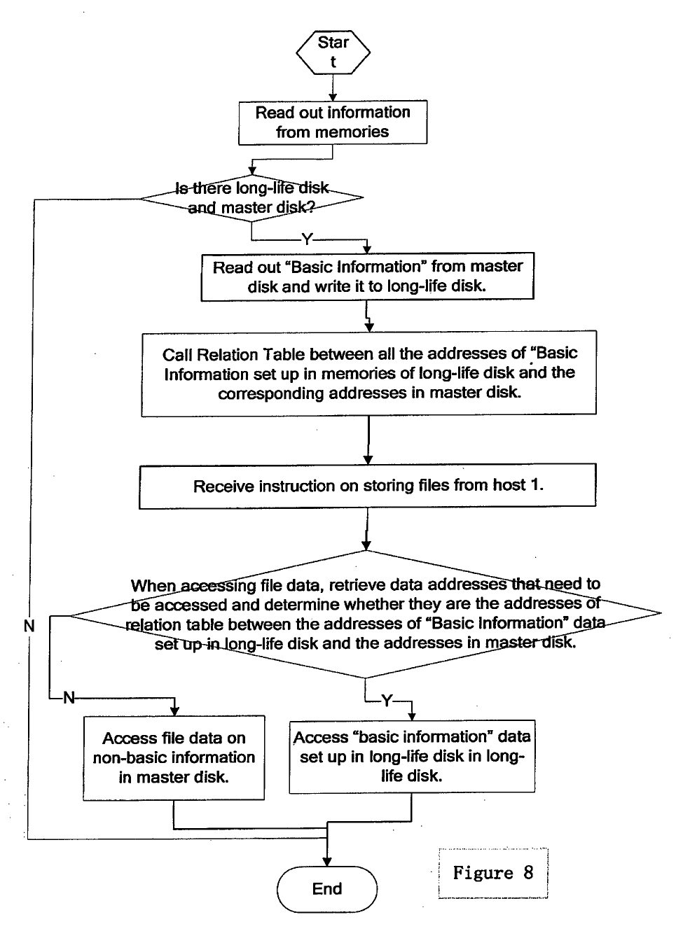

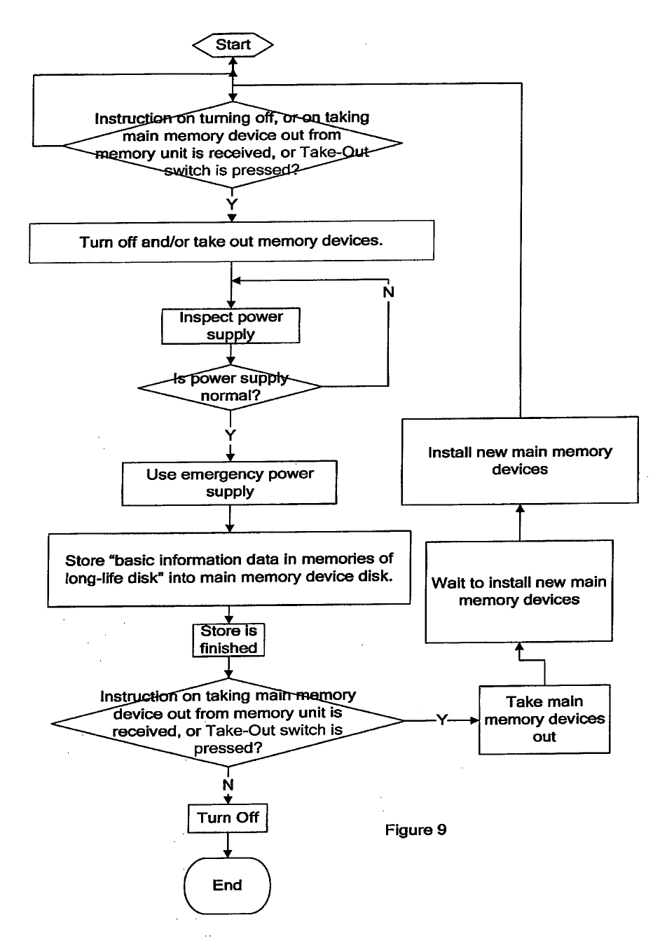

FIG. 8 and FIG. 9 show a program flowchart of store operation of changeable device memories of the present invention individually.

FIG. 8 shows a principle and processing methods of store operation program of changeable device memories of the present invention, including the following processing methods:

Program Principle and Processing Method:

(a) Starting; (b) Reading data that can be detected with auto-detection function of the main board BIOS hard disk out from the memories. According to request of program, through special programs and/or operation system or CPU controlling the memory, read out “Initialization Data Set” in sequence or call hardware installation information of the host; (c) Whether or not there is information about existence of log-life and master disk in “Initialization Parameter set” in the memories? (d) If YES (there is information about existence of log-life and master disk), then go to next step; if NO, quit; (e) Read out “Basic Information” from master disk and write it into long-life disk; (f) Call the Relation Table between the addresses of basic information in the long-life disk and the addresses in the master disk; (g) Receive file-storing instruction from the host 1; (h) When accessing file data, Retrieve addresses of data that need to be accessed and confirm whether those addresses are the addresses of “Basic Information” in the Relation Table set up in the master disk; (i) Access file data of non-“Basic Information” in the master disk; (j) Access file data of “Basic Information” set up in a long-life disk in the long-life disk and (k) end.

FIG. 9 shows a principle and processing methods of operation program of turning off changeable device memories or taking out memory devices of the present invention: (a) Start; (b) Whether a turn-off instruction is received? and/or be up to prior defined time; (c) Search after the instruction taking out main memory devices from the memory equipment or the information on pressing the Take-Out switch and/or up to prior defined time; (d) Having received a turn-off instruction and/or an instruction of memory-device-taking-out, and/or having been up to prior defined time; (e) Inspect power supply; (f) Power supply is interrupted? (g) If power supply has been interrupted, turn on the emergency power supply; (h) Store “Basic Information” in memories and the files stored into main memory device disk; (i) Storing operation is fulfilled; (j) An instruction on taking out main memory devices in the memory equipment is received or the Take-Out switch is pressed down? (k) If NO, turn off; (l) If YES, take out main memory devices; (m) Wait for taking in new main memory device; (n) After taking in new main memory device, return to “Start” of the program; and (o) End.

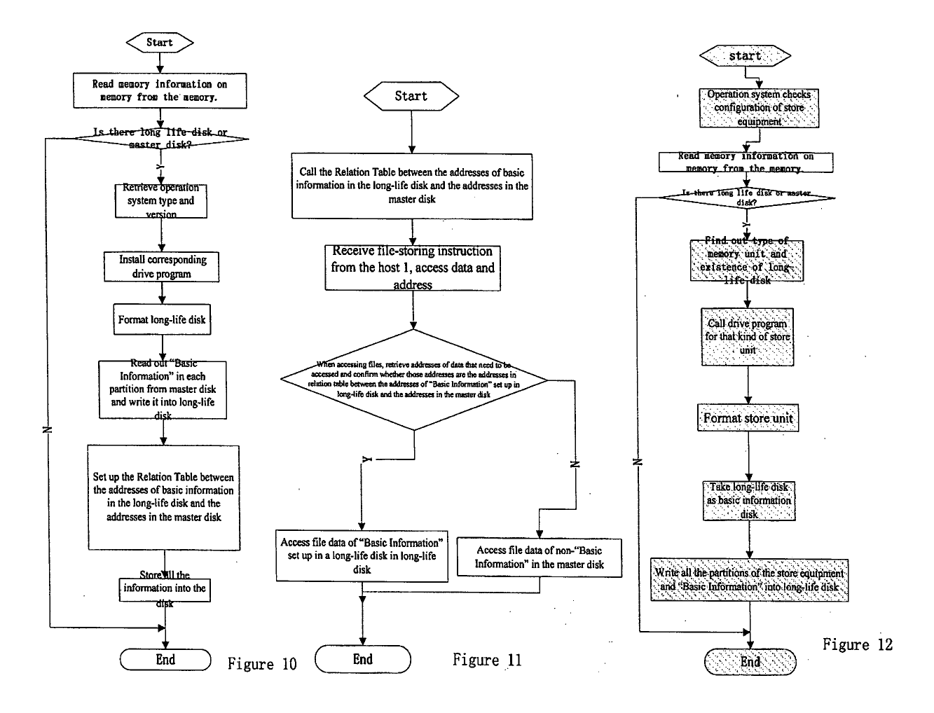

FIG. 10 and FIG. 11 show a program flowchart of store operation of the memories made by existing operation system.

When making partitions on the master disk, write “basic Information” in each partition into the master disk, and later on, access of data file for “Basic Information” shall be done directly in long-life disk. The principle and method of the present invention on long-life nonvolatile RAM disk is to insert a file management program for long-life nonvolatile RAM disk between file management program of operation system and magnetic disk management program, including installation program and operation program.

FIG. 10 is an installation program of long-life disk and processing method, including the following program:

(a) Starting; (b) Reading data that can be detected with auto-detection function of the main board BIOS hard disk out from the memories. Through special programs and/or operation system or CPU controlling the memory, read out “Initialization Data Set” in sequence or call hardware installation information of the host; (c) Whether or not there is information about existence of log-life and master disk in “Initialization Parameter set” in the memories? (d) If YES (there is information about existence of log-life and master disk), then go to next step; if NO, quit; (e) Retrieve operation system type and version; (f) Install corresponding drive program; (g) Format long-life disk; (h) Read out “Basic Information” in each partition from master disk and write it into long-life disk; (i) Set up the Relation Table between the addresses of basic information in the long-life disk and the addresses in the master disk; (j) Store all the information into the disk; (k) End.

FIG. 11 shows a principle and processing methods for store operation program of operation of long-life memory, including the following program (operation program): (a) Start; (b) Receive file-storing instruction from the host 1, access data and address; (c) When accessing files, retrieve addresses of data that need to be accessed and confirm whether those addresses are the addresses in relation table between the addresses of “Basic Information” set up in long-life disk and the addresses in the master disk; (d) Access file data of “Basic Information” set up in a long-life disk in the long-life disk; (e) Access file data of non-“Basic Information” in the master disk; and (f) The system reads “Basic Information” on the drive equipment out from the long-life disk; and (g) end.

Every disk is independent one. It is possible to set up disk mark storing data files as C:\, D:\, E:\ . . . and log-life disk storing “Basic Information” as CI:\, D:\, E:\ . . . so that it shall be easy to identify them each other. Of course, those disk marks may be changeable according to design requirements.

FIG. 12 is a flow chart of store operation of the memory by changed operation system. When using long-life nonvolatile disk and setting up partitions on the master disk, directly set “Basic Information” into each partition of the long-life disk, later on, access of data file for “Basic Information” shall be done directly in long-life disk. The principle and processing method of installing and using log-life disk is as follows:

(a) Start; (b) Operation system checks configuration of store equipment; (c) Read out “Initialization Data Set” from the memories or call hardware installation information of the host; (d) Whether or not there is information about existence of log-life and master disk in “Initialization Parameter set” in the memories? (e) Call drive program for that kind of store equipment; (f) Format store equipment; (g) Take long-life disk as basic information disk; (h) Write all the partitions of the store equipment and “Basic Information” into long-life disk; and (i) End. From this time on, when using operation system to do store operation, directly access “Basic Information” in long-life disk.

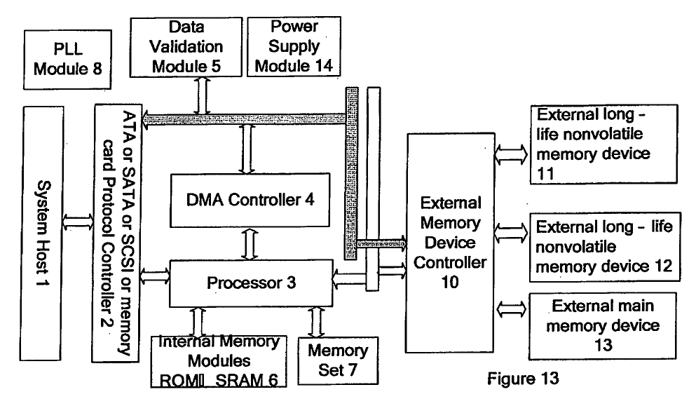

FIG. 13 is a circuit bock diagram of hardware layout for another embodiment of this invention.

That is a circuit for memory control chip of medium-life nonvolatile semiconductor disk or other disks.

The hardware layout in that embodiment is same as that in FIG. 1 in the main, but this embodiment uses same kind of nonvolatile memory devices as the main memory ones (more read/write times than the main memory devices). As that kind of memory devices with more readable/writable frequency as long-life memory devices, external main nonvolatile semiconductor memory device controller 10 is able to control such memories as that consist of external nonvolatile semiconductor memory devices 11 and 12 and medium life main nonvolatile semiconductor memory device 13 individually. External long-life nonvolatile semiconductor memory devices 11 and 12 may use multiple kinds or only one kind of memory device, or External long-life nonvolatile semiconductor memory devices 12 may not be used. Write information that there is long-life disk and master disk in the memory into “Initialization Parameter Set” in the memory, which shall be used for recognition of main board equipment and operation system equipment.

At the present, even though there is such a memory that one memory controller controls multiple same kinds of memory devices, such as CF card, SD card, DOM card and so on, in which, readable/writable frequency of each memory device may be different, but “Basic Information” in main memory device doesn't be written into a disk with more readable/writable frequency so that their operation life is limited because of operation life of main memory devices. The present invention uses long-life nonvolatile memory hardware and writes “Basic Information” in main memory into long-life disk; in addition, it shall be in long-life disk where data access and processing shall be done with “Basic information” and device drive program or memory operation system program stored in long-life disk instead in master disk, so as to increase operation life of main memory devices.

For example, a master disk that is made of the flash chips with operation life of ten or more than ten thousand readable/writable times and a long-life nonvolatile memory device disk that is made of the flash chips with operation life of hundred or more than hundred thousand readable/writable times are combined in a unit, in addition, it shall be in long-life disk where data access and processing shall be done with “Basic information” and device drive program or memory operation system program stored in long-life disk instead in master disk, so that the original short life master disk with low cost and low level of readable/writeable times shall become a long-life disk.

When making access operation of file data in the memories of the present invention, according to design requirements, first of all, store data on full disk in regular sequence; and then according to the principle “First Canceling, First Storing; Later Canceling; Later Storing”, carry on access operation of the memories till the disk is written fully. The advantage of that kind of data access is to prevent a memory region or a memory partition from reading/writing again and again in a short time and from reducing its operation life.

Each module and each element as well as each function used by the present invention can be increased or reduced according to design requirements. The circuit diagram or flow chart in each Figure can be changed according to design requirements or different elements used.

The forgoing detailed description is given for clearness of understanding only and no unnecessary limitation should be understood therefrom, as modifications, change or replacement or other application of long-life nonvolatile memory chip of the present invention will be obvious to those skilled in the art.

1. A circuit capable of increasing operation life of a memory, including:
a main memory device;
a main memory device controller for controlling data access of the main memory device, forming a main memory together with the main memory device; characterized by further including:
a long-life memory device for storing basic information and/or other data that need to be written or read frequently, and
a long-life memory device controller for controlling data access of the long-life memory device, forming a long-life memory together with the long-life memory device.

2. The circuit defined in claim 1, wherein said main memory is an external memory or an internal memory.

3. The circuit defined in claim 1, wherein said long-life memory device is a nonvolatile memory device or a random access memory device.

4. The circuit defined in claim 1, wherein said long-life memory device is a magnetic RAM (MRAM), a resistance RAM (RRAM), a ferroelectric RAM (FeRAM), a phase transformation materials OUM memory (Phase transformation internal memory PRAM), or a super high density memory chip (MILLIPEDE) device.

5. The circuit defined in claim 1, wherein said main memory is an optical memory, a magneto-optical memory, or an internal/external nonvolatile semiconductor memory which is used in ATA, or SATA, or SCSI, or memory card, or USB, or Blue Teeth or IEEE 1394 interface.

6. A method for increasing operation life of a memory using the circuit defined in claim 1, including the following steps when carrying on access of memories:
(1) initializing the long-life memory, reading out basic information and/or other data that need to be written or read frequently from the main memory and storing them into the long-life memory device;
(2) setting up a relation table between addresses of the basic information and/or other data stored in the long-life device and addresses in the main memory device;
(3) during data access operation, retrieving addresses of data that need to be written or read and determining whether said addresses of said data are already stored in the relation table, if the answer is positive, the data access operation will be performed in the long-life memory, otherwise, the data access operation will be performed in the main memory.

7. The method for increasing operation life of a memory defined in claim 6, wherein said method includes the following step when turning off or taking out the main memory device and when the main memory comprises a medium that needs to be replaced frequently:
determining whether the power supply is interrupted, if it is interrupted, starting an spare power supply.

8. The method for increasing operation life of a memory defined in claim 6, wherein basic information in all partitions is stored in the main memory while making the partitions of the main memory and, later, access operation of basic information for digital data files is carried out directly in the long-life memory.

9. The method for increasing operation life of a memory defined in claim 8, further comprising the following steps:
(1) installing a corresponding drive program;
(2) formatting said long-life memory.

10. The method for increasing operation life of a memory defined in claim 6, wherein basic information in all partitions is stored in the long-life memory while making the partitions of the main memory and, later, access operation of basic information for digital data files is carried out directly in the long-life memory.

11. The method for increasing operation life of a memory defined in claim 9, further comprising the following steps:
(1) formatting said main memory;
(2) storing all partition tables and basic information that needs to be read and written frequently into said long-life memory.

12. The method for increasing operation life of a memory defined in claim 6, wherein said method includes the following steps when said main memory or said long-life memory is a nonvolatile memory device: writing data stored in corresponding memories into BIOS of CPU for controlling external memories.

13. The method for increasing operation life of a memory defined in claim 6, wherein said basic information in said long-life memory and/or in said main memory is written into an internal initialization parameter table for controlling external memories.

14. The method for increasing operation life of a memory defined in claim 6, wherein said method includes the following step when turning off or taking out the main memory device and when the main memory comprises a medium that needs to be replaced frequently:
storing the basic information and/or other data stored in the long-life memory, which need to be written and read frequently, into the main memory device.

15. A method for increasing operation life of memory defined in claim 8, wherein said method includes the following:
(1) reading out basic information and/or other data in each partition from said main memory and writing the basic information and/or other data into said long-life memory;
(2) setting up the relation table between the data addresses of basic information stored in said long-life memory and the addresses in said main memory and storing the relation table into said long-life memory.
